(19) United States
(12) Patent Application Publication
(10) Pub. No.: US 2015/0046174 A1
(43) Pub. Date: Feb. 12, 2015

(54) COMPUTER-AIDED MEDICAL DIAGNOSING AND PRESCRIPTIONS

(71) Applicant: ORCA HEALTH, INC., Sandy, UT (US)

(72) Inventors: Piers A. Mainwaring, Salt Lake City, UT (US); Matthew M. Berry, Park City, UT (US); Lauren Soelberg, Sandy, UT (US); Chad Zeluff, Murray, UT (US); Jordan Brown, Salt Lake City, UT (US); James Cole Herrmann, Draper, UT (US); Dan Lyman, Provo, UT (US); Gary Robinson, Sandy, UT (US)

(21) Appl. No.: 14/251,400

(22) Filed: Apr. 11, 2014

Related U.S. Application Data
(60) Provisional application No. 61/864,954, filed on Aug. 12, 2013.

(51) Int. Cl. G06F 19/00; G06F 3/0488; G06F 3/0482

(52) U.S. Cl. CPC G06F 19/3456; G06F 3/0482; G06F 3/0488
USPC 705/2

(57) ABSTRACT

Embodiments herein are directed to user interfaces and methodologies for computer-aided medical diagnosing and prescriptions. In one embodiment, a user interface is presented, which includes a selectable menu option for each of a plurality of content types. Each selectable menu option is configured to present medical content relevant to the corresponding content type, when selected. Based on user input entered in connection with navigating the content types, one or more content items are identified as part of a prescription, and a selectable user interface element is presented for sending of the prescription to a patient computer system. Other embodiments include creating and modifying prescriptions based on evaluation questions. In one embodiment, medical content is added to a prescription based on the user's answer to an evaluation question. In another embodiment, a prescription is modified based on a user's answer to an evaluation question.

### CROSS-REFERENCE TO RELATED APPLICATIONS

This application claims priority to, and the benefit of, U.S. Provisional Application No. 61/864,954, which was filed Aug. 12, 2013, and which is entitled “SYSTEMS AND METHODS FOR MANAGING MEDICAL PRODUCTS AND SERVICES.” The contents of the foregoing provisional application are expressly incorporated by reference herein in its entirety.

### BACKGROUND

1. Field of the Invention

This invention generally relates to methods, systems, and computer program products for aiding both physician and patient during medical diagnosis, education, treatment, and recovery.

2. Background and Relevant Art

The procedural workflow of medical diagnosis, treatment, and recovery has changed very little over recent decades. A typical treatment scenario entails a patient experiencing some physiological symptom, and the patient visiting a physician for diagnosis of the condition causing the symptoms, and for treatment of that condition. During the visit, the physician examines the patient to arrive at a diagnosis. As part of examination and diagnosis, the physician may instruct the patient to undergo some lab procedure (e.g., blood tests, imaging tests such as X-Ray, MRI, CT-Scan, etc.). Once the physician has reached a diagnosis, the physician can inform the patient of his treatment options, and let the patient make a determination as to the treatment path she would like to take, if any.

During the examination and diagnosis process, the physician may provide the patient with verbal instructions and education, and/or generic printed publications that educate the patient about the condition, treatment options, and other considerations. Further, the physician may provide the patient with additional verbal instructions and/or generic printed publications that include instructions for the patient to follow during her treatment procedure (e.g., a surgical or a non-surgical procedure). Still further, the physician may provide the patient with yet additional verbal instructions and/or generic printed publications that include instructions for the patient to follow during her recovery.

During the foregoing examination, treatment, and recovery processes, the patient may have questions or concerns, or the patient's symptoms may not change (e.g., improve) as expected. In such cases, the patient typically calls the physician and/or schedules an in-person follow-up appointment. In many cases, a plurality of visit and treatment/recovery cycles may be necessary to address the patient's symptoms/condition, many of which may be merely educational or instructional in nature. As such, the current procedural workflow of medical diagnosis and treatment can lead to inefficiencies and waste of time and resources, for both the physician and the patient.

### BRIEF SUMMARY

At least some embodiments described herein address inefficiencies in the current medical diagnosis, treatment, and recovery cycle. Embodiments herein include methods, systems, and computer program products that increase engagement between physician and patient throughout the entire medical diagnosis, treatment, and recovery cycle, that provide for rich educational opportunities, and that ensure patient understanding and informed consent.

Some embodiments include presenting a user interface for medical diagnosing and prescriptions. Presenting a user interface includes identifying a plurality of content types relative to a particular medical condition for presentation in a medical educational interface. The plurality content types are selected from among the group comprising: diagnosis, surgical treatment, non-surgical treatment, quiz, and informed consent. Presenting the user interface also includes presenting a selectable menu option for each of the identified plurality of content types. Each selectable menu option is configured to present medical content relevant to corresponding content type, when selected. Presenting the user interface also includes identifying, from user input entered in connection with a selected menu option for at least one of the plurality of content types, one or more content items that are part of a prescription. Presenting the user interface also includes presenting a selectable user interface element that, when selected, initiates sending of the prescription, including the one or more content items, to a patient computer system.

Some embodiments include creating a prescription. Creating a prescription includes presenting one or more evaluation questions to a user. The evaluation questions are relevant to ascertaining a user's treatment preferences. Creating the prescription also includes identifying one or more items of medical content that are available for addition to a prescription and for dissemination to a user. Creating the prescription also includes, based on the user's answer to at least one of the evaluation questions, automatically adding at least one of the items of medical content to the prescription for dissemination to the user.

Some embodiments include modifying a prescription. Modifying a prescription includes, identifying one or more items of medical content that are included as part of a prescription for dissemination to a user. The items of medical content are included in the prescription based on an express selection by a first user and/or interaction with one of the items of medical content at a user interface. Modifying the prescription also includes identifying one or more answers by a second user to one or more evaluation questions. The evaluation questions are relevant to ascertaining the second user's treatment preferences. Modifying the prescription also includes, based on the second user's answer to at least one of the evaluation questions, automatically modifying the prescription to include at least one additional item of medical content.

This summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 illustrates an example network architecture in which embodiments of the invention may be implemented and/or performed, according to one or more embodiments.

FIG. 2 illustrates a data flow that may be practiced in the network architecture of FIG. 1, according to one or more embodiments.

FIG. 3 illustrates an example process flow of a diagnosis, treatment, and recovery cycle, according to one or more embodiments.

FIG. 4A illustrates an example educational/decision aid user interface for a particular medical condition, including media for a diagnosis content option, according to one or more embodiments.

FIG. 4B illustrates an example educational/decision aid user interface for a particular medical condition, including text for a diagnosis content option, according to one or more embodiments.

FIG. 4C illustrates an example educational/decision aid user interface for a particular medical condition, including an anatomical model, according to one or more embodiments.

FIG. 4D illustrates an example educational/decision aid user interface for a particular medical condition, including an annotation interface, according to one or more embodiments.

FIG. 4E illustrates an example educational/decision aid user interface for a particular medical condition, including a normal/abnormal content type, according to one or more embodiments.

FIG. 4F illustrates an example educational/decision aid user interface for a particular medical condition, including media for a surgery content option, according to one or more embodiments.

FIG. 4G illustrates an example educational/decision aid user interface for a particular medical condition, including text for a diagnosis content option, according to one or more embodiments.

FIG. 4H illustrates an example educational/decision aid user interface for a particular medical condition, including risks and benefits content, according to one or more embodiments.

FIG. 4I illustrates an example educational/decision aid user interface for a particular medical condition, including quiz content, according to one or more embodiments.

FIG. 4J illustrates an example educational/decision aid user interface for a particular medical condition, including consent form content, according to one or more embodiments.

FIG. 5A illustrates an example electronic communication, according to one or more embodiments.

FIG. 5B illustrates an example account creation page, according to one or more embodiments.

FIG. 5C illustrates an example web portal user interface, according to one or more embodiments.

FIG. 6A illustrates an example web user interface for uploading content, according to one or more embodiments.

FIG. 6B illustrates an example web user interface for editing content, according to one or more embodiments.

FIG. 7 illustrates a flow chart of an example method for presenting a user interface for medical diagnosing and prescriptions, according to one or more embodiments.

FIG. 8 illustrates a flow chart of an example method for creating a prescription, according to one or more embodiments.

FIG. 9 illustrates a flow chart of an example method for modifying a prescription, according to one or more embodiments.

### DETAILED DESCRIPTION

At least some embodiments described herein address inefficiencies in the current medical diagnosis, treatment, and recovery cycle. Embodiments herein include methods, systems, and computer program products that increase engagement between physician and patient throughout the entire medical diagnosis, treatment, and recovery cycle, that provide for rich educational opportunities, and that ensure patient understanding and informed consent.

Some embodiments include presenting a user interface for medical diagnosing and prescriptions. Presenting a user interface includes identifying a plurality of content types relative to a particular medical condition for presentation in a medical educational interface. The plurality content types are selected from among the group comprising: diagnosis, surgical treatment, non-surgical treatment, quiz, and informed consent. Presenting the user interface also includes presenting a selectable menu option for each of the identified plurality of content types. Each selectable menu option is configured to present medical content relevant to corresponding content type, when selected. Presenting the user interface also includes identifying, from user input entered in connection with a selected menu option for at least one of the plurality of content types, one or more content items that are part of a prescription. Presenting the user interface also includes presenting a selectable user interface element that, when selected, initiates sending of the prescription, including the one or more content items, to a patient computer system.

Some embodiments include creating a prescription. Creating a prescription includes presenting one or more evaluation questions to a user. The evaluation questions are relevant to ascertaining a user's treatment preferences. Creating the prescription also includes identifying one or more items of medical content that are available for addition to a prescription and for dissemination to a user. Creating the prescription also includes, based on the user's answer to at least one of the evaluation questions, automatically adding at least one of the items of medical content to the prescription for dissemination to the user.

Some embodiments include modifying a prescription. Modifying a prescription includes, identifying one or more items of medical content that are included as part of a prescription for dissemination to a user. The items of medical content are included in the prescription based on an express selection by a first user and/or interaction with one of the items of medical content at a user interface. Modifying the prescription also includes identifying one or more answers by a second user to one or more evaluation questions. The evaluation questions are relevant to ascertaining the second user's treatment preferences. Modifying the prescription also includes, based on the second user's answer to at least one of the evaluation questions, automatically modifying the prescription to include at least one additional item of medical content.

Embodiments herein include the creation, selection, and dissemination of medical information (e.g., educational materials, instructions, quizzes, consent forms, surveys, etc.) from a medical professional to a patient. In particular, the embodiments described herein enable a medical professional to select materials to be sent to a patient as part of a “prescription,” and send that prescription to the patient (e.g., by providing the patient information sufficient to access that prescription at a repository, such as a cloud-based service, or pushing the prescription to the patient).

As used in the following description and claims, a “prescription” can comprise any collection of educational information, instructions, authorizations, testing materials, consent materials, or other items that a medical professional disseminates to a patient. For example, a prescription may include educational information in the form of 3D anatomical models, 2D anatomical illustrations or photographs, textual information, videos, animations, etc., including educational information that has been annotated; physician-generated content such as images and/or videos of a patient's condition, dictations, etc., including physician-generated content that has been annotated; pharmaceutical prescriptions (e.g., for drugs); forms (e.g., authorization, informed consent); surveys; decision aids; or any other relevant information that a medical professional may desire to disseminate to a patient. A “prescription” as used herein can also include items more traditionally associated with the term, such as a an electronic prescription of a pharmaceutical drug, and order for a service (e.g., for services such as physical therapy), an order for laboratory tests, imaging (e.g., radiographic imaging), etc.

### Cloud-Based Architecture

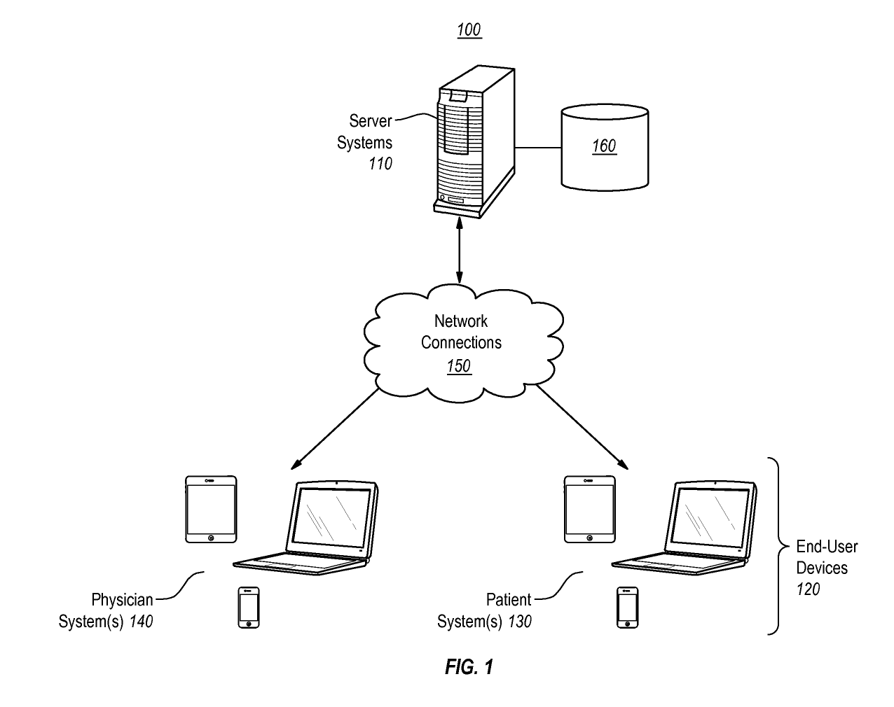

FIG. 1 illustrates an example network architecture 100 in which embodiments of the invention may be implemented and/or performed. As depicted, the network architecture 100 includes server system(s) 110 and end-user devices 120 (including one or more patient systems 130 and one or more physician systems 140). Each of the depicted systems are connected by one or more network connections 150. The network connections 150 can comprise any appropriate combination of local or wide-area networks, including, for example, the Internet. In one embodiment, the physician system(s) 140 and the server system(s) 110 is/are interconnected using a local area connection (LAN), while the patient system(s) 130 is/are interconnected with the medical professional system(s) 140 and/or the server system(s) 110 using a wide area network (WAN) connection, such as the Internet.

One or more of the illustrated systems (e.g., server system(s) 110, patient system(s) 130, and physician system(s) 140) can be embodied on a single physical computing system, or may include a plurality of networked devices. These devices can be located at a single location or at multiple locations, such as, for example, within distributed networks and cloud configurations. In a cloud configuration, remote computer systems are used singly or in combination with local computer systems to perform tasks (e.g., information processing, data storage, etc.). In a distributed environment, program modules may be located in both local and remote memory storage devices. For example, in some embodiments the server system(s) 110 comprise cloud-based systems, in which one or both of storage or processing resources are at least partially embodied in a cloud-based service, such as a service offered by AMAZON, MICROSOFT, GOOGLE, etc.

Each of the illustrated systems can comprise one or more computing devices, such as desktop computers, laptop/notebook computers, message processors, hand-held devices, multi-processor systems, microprocessor-based or programmable consumer electronics, network PCs, minicomputers, mainframe computers, tablets, mobile telephones, PDAs, pagers, routers, switches, servers, kiosks, gaming systems and/or any other computing device.

An end-user device 120 may include a touch-sensitive screen that is utilized to receive user input and to display output associated with the user interfaces of the invention. In other embodiments, keyboards, rollers, touch pads, sticks, mice, microphones and other input devices are used to receive input. Speakers and display screens, which are not touch sensitive, can also be used to render corresponding output.

The server system(s) 110 include one or more hardware processors and other computer hardware (e.g., input devices, output devices, other processing devices, etc.), as well as storage 160 (e.g., a recordable-type storage device). The server system(s) 110 can be configured to provide data and services to the physician system(s) 140 and/or the patient system(s) 130. For example, the storage 160 may store data objects, which are placed in the storage 160 by the physician system(s) 140 and/or the patient system(s) 130, and which are then made accessible by the physician system(s) 140 and/or the patient system(s) 130 directly, through a web portal, etc.

In one example, the data objects stored in storage 160 may include patient/individual medical records that are created/updated by medical professionals using the physician system(s) 140, and that are accessed by patients using the patient system(s) 130. In another example, the data objects in storage 160 may include prescriptions that include educational materials, instructions, or other medical products and service data (which is separate from, or a part of, patient/individual medical records), and that are created/updated by medical professionals using the physician system(s) 140, and that are accessed by patients using the patient system(s) 130. In another example, the data objects stored in storage 160 may include one or more libraries of educational content that can be made available to physician system(s) 140 and/or the patient system(s) 130. In some embodiments, such educational content may be authored or otherwise provided by a physician using a physician system 140. In another example, the data objects stored in storage 160 may include user profiles for medical professionals and/or patients who use network architecture 100.

In some embodiments, the data objects stored in storage 160 include some data of limited accessibility, such as data that is accessible only by a physician, data that is accessible only by a patient, or combinations thereof. For example, a single patient record may include annotations, comments, or other data that is flagged as accessible only by the physician, and annotations, comments, or other data that can be accessed by both the physician and the patient. As such, when the record is displayed to a physician, the physician sees the whole record; by contrast, when the record is displayed to the patient, the patient sees only a portion of the record. In other embodiments, data accessible only by the physician is stored in a separate record.

The physician system(s) 140 can include any computer systems that are used by medical professionals to implement embodiments of the present invention, such as to generate prescriptions (or other medical products and service data), to create/update medical records, etc. The physician system(s) 140 may include or be otherwise configured to display web-based, mobile user, or other user interfaces. For example, the physician system(s) 140 may comprise a desktop computer running a web browser that loads a web page provided by the server system(s) 110, may comprise a mobile device (e.g., tablet, smartphone) running an application (app) that interfaces with the server system(s) 110, or may comprise any other appropriate computer system that interfaces with the server system(s) 110, in the manners disclosed herein.

Similarly, the patient system(s) 130 can include any computer system(s) that is/are used by patients in connection with use of the network architecture 100, such as to receive and view prescriptions, view medical records, update medical information, etc. The patient system(s) 130 may include or be otherwise configured to display web-based, mobile, or other user interfaces. For example, patient system 130 may comprise a desktop computer running a web browser that loads a web page provided by the server system(s) 110, may comprise a mobile device (e.g., tablet, smartphone) running an application (app) that interfaces with physician system(s) 140, or may comprise any other appropriate computer system that interfaces with the server system(s) 110, in the manners disclosed herein.

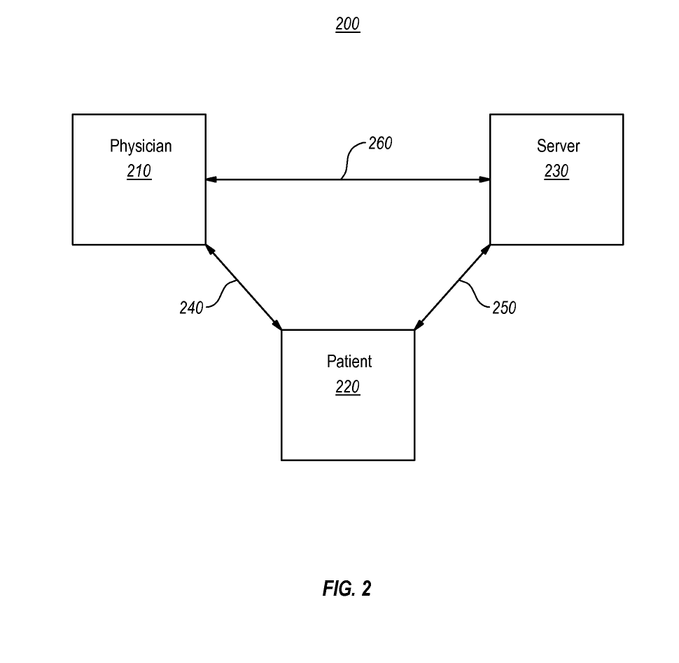

FIG. 2 illustrates a data flow 200 that may be practiced in the network architecture 100 of FIG. 1. In the process flow 200, a physician 210 generates data for dissemination to a patient 220. For example, a physician 210 operating a physician system 140 may generate a prescription, or data relating to other medical products and services, for a patient. The prescription may include educational or documentary data in the form of 3D models, 2D illustrations, photographs, textual data, videos, voice recordings, etc. The prescription may also include identification of one or more conditions, procedures, medicines, services (e.g., MRI, X-Ray), etc. The prescription may also include quizzes, consent forms, or other mechanisms for engaging the patient and ascertaining patient understanding.

As depicted by the arrow 240, the physician 210 sends the prescription (or other medical products and service data) to the patient 220. For example, a physician system 140 may present one or more user interface that enable the physician 210 to enter or select contact information (e.g., e-mail address, phone number, address, identification number, name, etc.) for the patient 220, and initiate sending of the prescription to the patient (e.g., to a patient system 130).

In some embodiments, the prescription is sent directly to the patient 220, such as in an electronic communication from the physician system 140 to the patient system 130. In other embodiments, the prescription is sent to the through server 230. For example, the physician system 140 may send the prescription to the server system(s) 110 (e.g., arrow 260), which then relays the prescription to the patient system 130 (e.g., arrow 250). Combinations are also possible. For example, the physician system 140 may send the prescription to the server system(s) 110. Then, the physician system 140 and/or the server system(s) 110 may send a notification to the patient system 130, informing the patient 220 that a prescription is waiting at the server 230.

Whatever the path a notification is received through, the patient 220 would typically retrieve the prescription from the server 230. For example, the patient 220 may visit a web page presented by the server 230 with a patient system, and authenticate with patient credentials. There, the patient 220 can view the contents of the prescription, including any educational or documentary data in the form of 3D models, 2D illustrations, photographs, textual data, videos, voice recordings, or identification of conditions, procedures, medicines, services (e.g., MRI, X-Ray), quizzes, consent forms, etc.

The server 230 can increase the efficiency of a medical practice by actively engaging the patient, by providing the patient with customized data and instructions, and by enabling the patient to send and receive communications with the physician. For example, such communications can prevent some of the most common calls from patients, such as, ‘what did the physician go over with me?’ or ‘what do I need to do to get better?’, since this information can already be contained in a prescription that is accessible by the patient 220 at the server 230. In addition, the server 230 can help patients resolve questions such as, ‘do you take my insurance?’ by presenting insurance information (e.g., in a web page). In some embodiments, the server 230 may correlate insurance information in a patient's profile with a medical practice, to automatically resolve insurance questions, or to present only physicians at the practice who participate in that patient's insurance program.

In addition to sending prescriptions to patients, the network architecture 100 of FIG. 1 enables physicians to engage in rich communications with patients. For example, a physician may be enabled to initiate push or pull notifications to a patient device 130, such as to remind the patient to take a medication, to fast prior to a medical test or procedure, etc.

### Positive Feedback Process

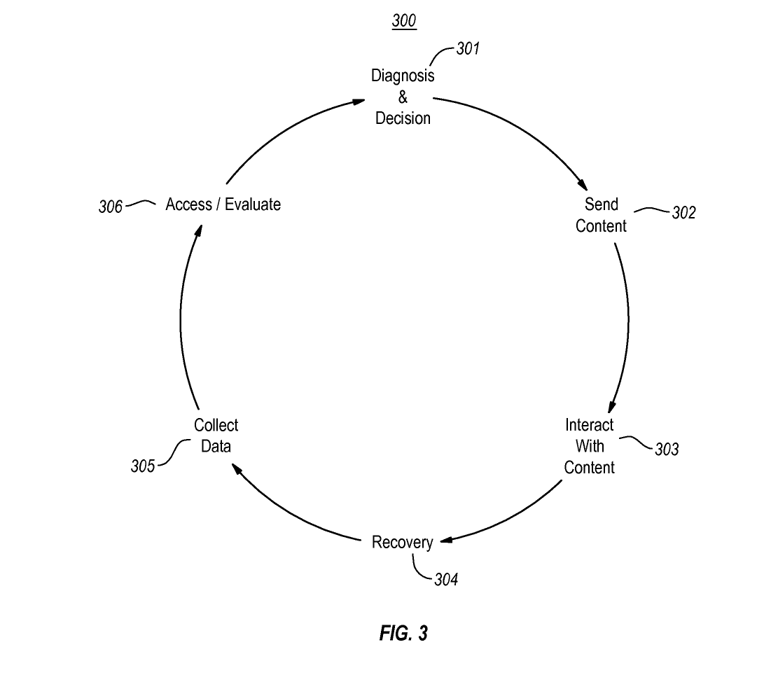

The network architecture 100 of FIG. 1 can enable a computer-assisted positive feedback process during medical diagnosis, treatment, and recovery. For example, FIG. 3 illustrates an example process flow 300 of a diagnosis, treatment, and recovery cycle that utilizes network architecture 100 to increase patient engagement and to improve care for one or more patients through feedback to the physician.

One of ordinary skill in the art will appreciate that while, for simplification in description, the process flow 300 is described using a particular sequence of steps, the process flow is not limited to the ordering shown in FIG. 3. For example, one or more steps may iterate prior to moving to the next step, or some steps may occur in different orders than those depicted. As such, process flow 300 is intended to merely illustrate one manner in which the steps of the process may proceed.

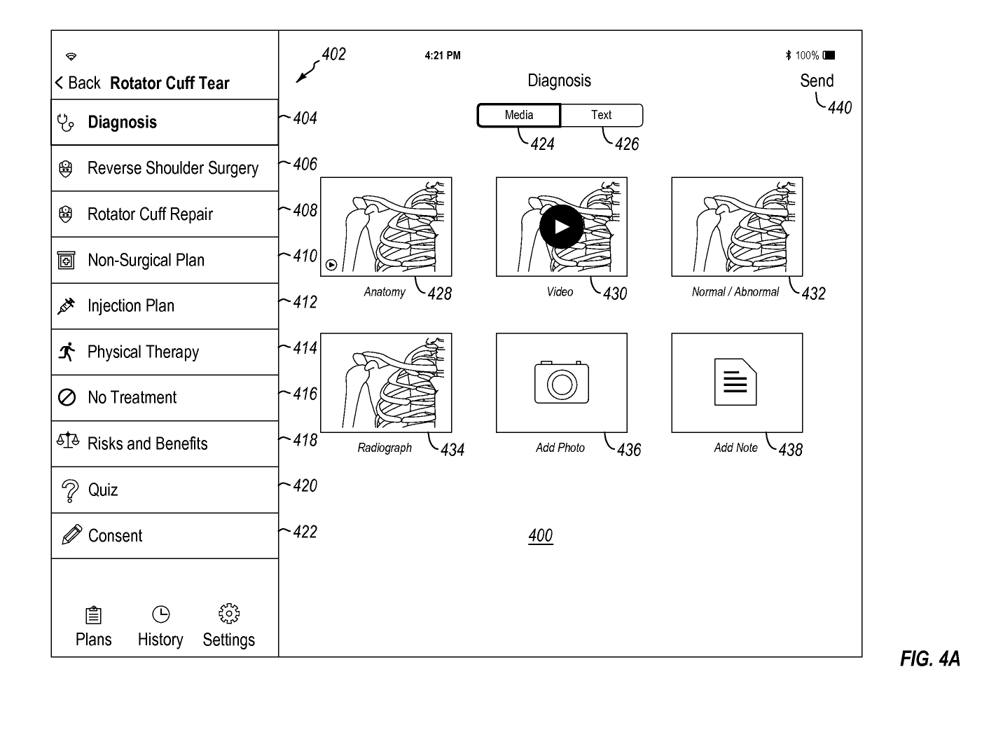

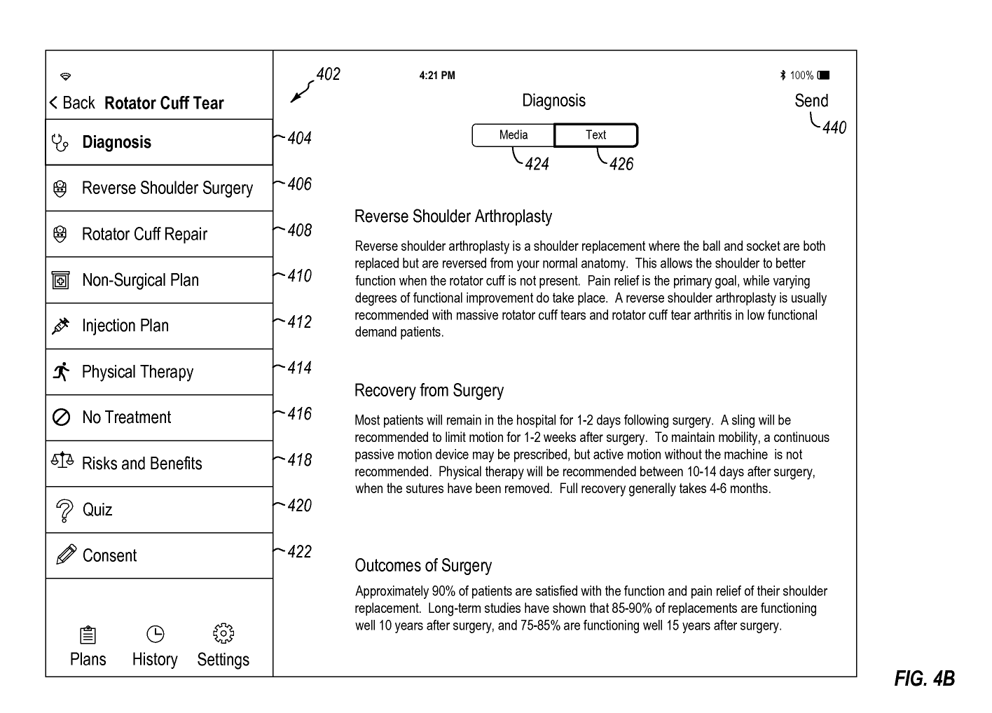

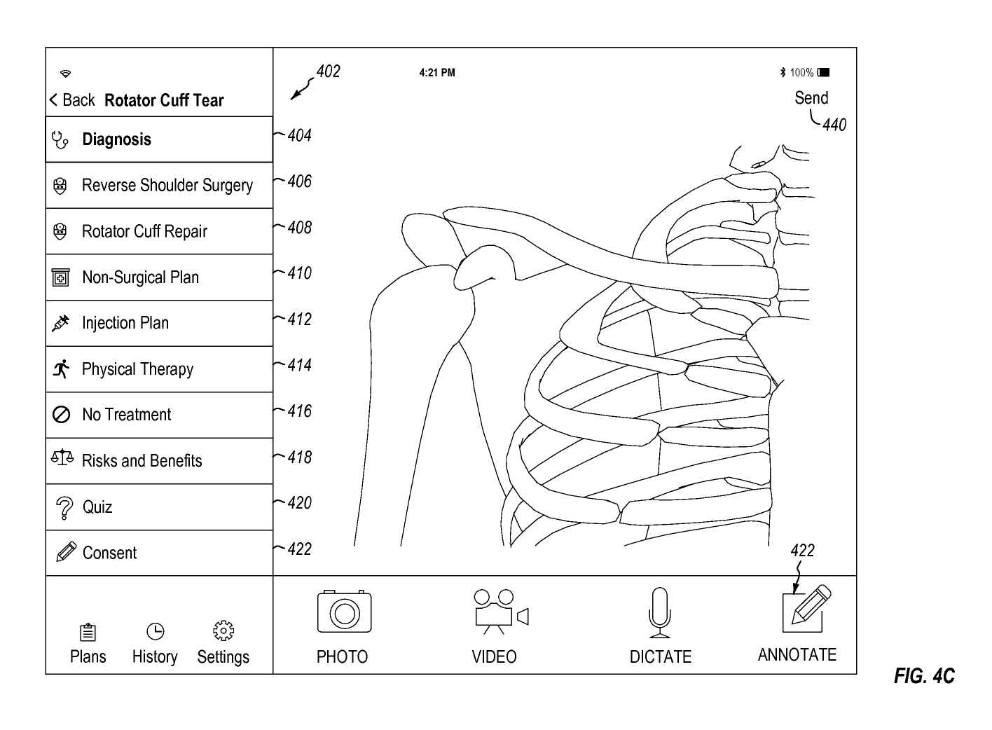

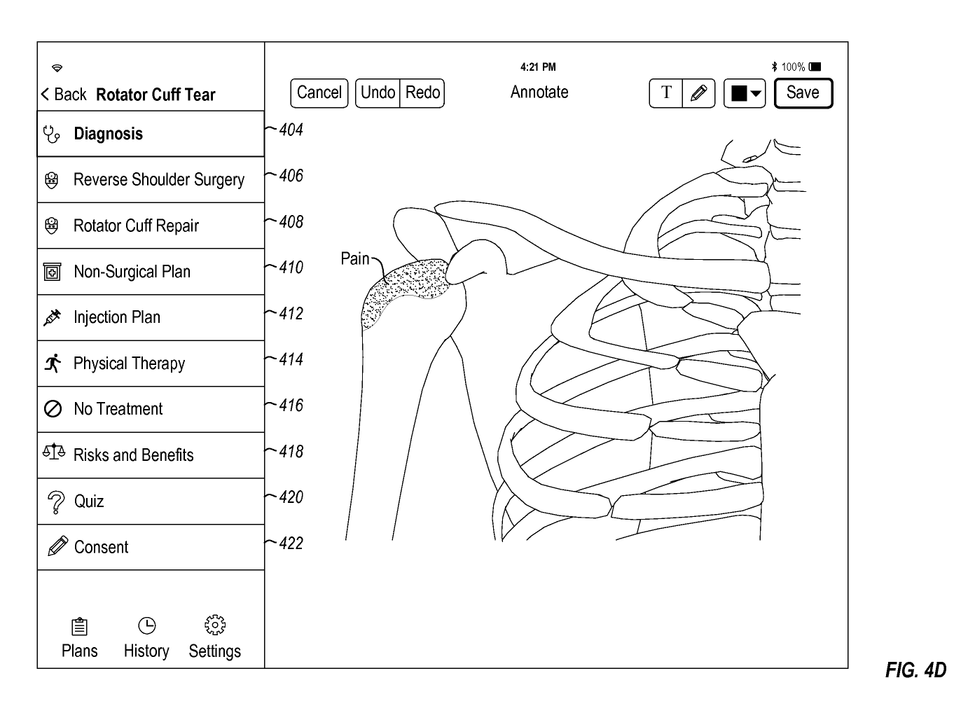

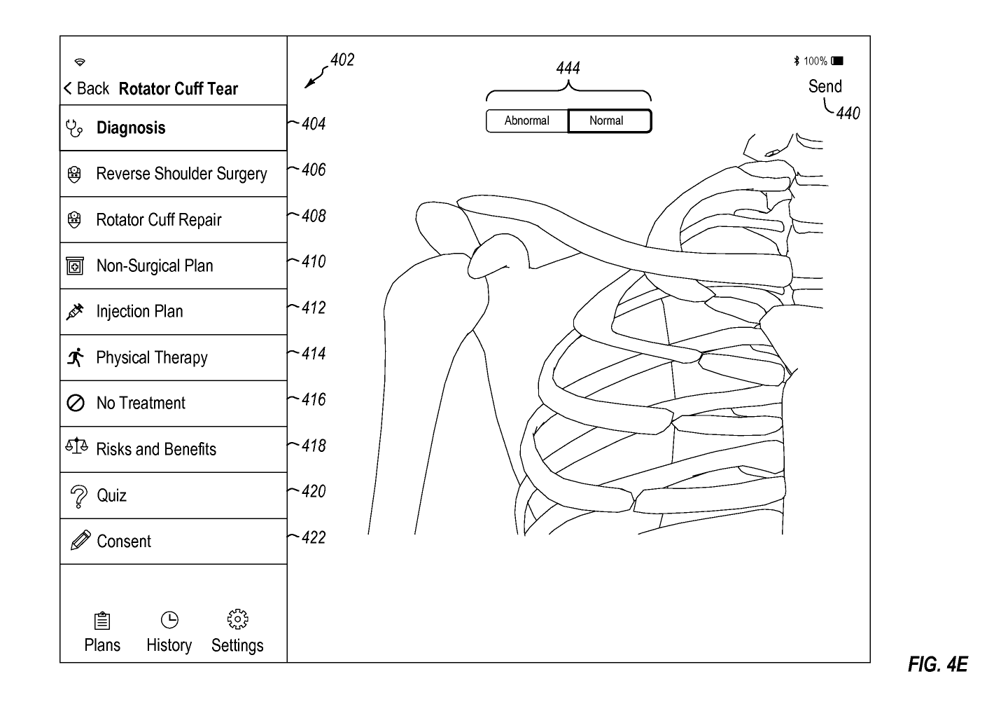

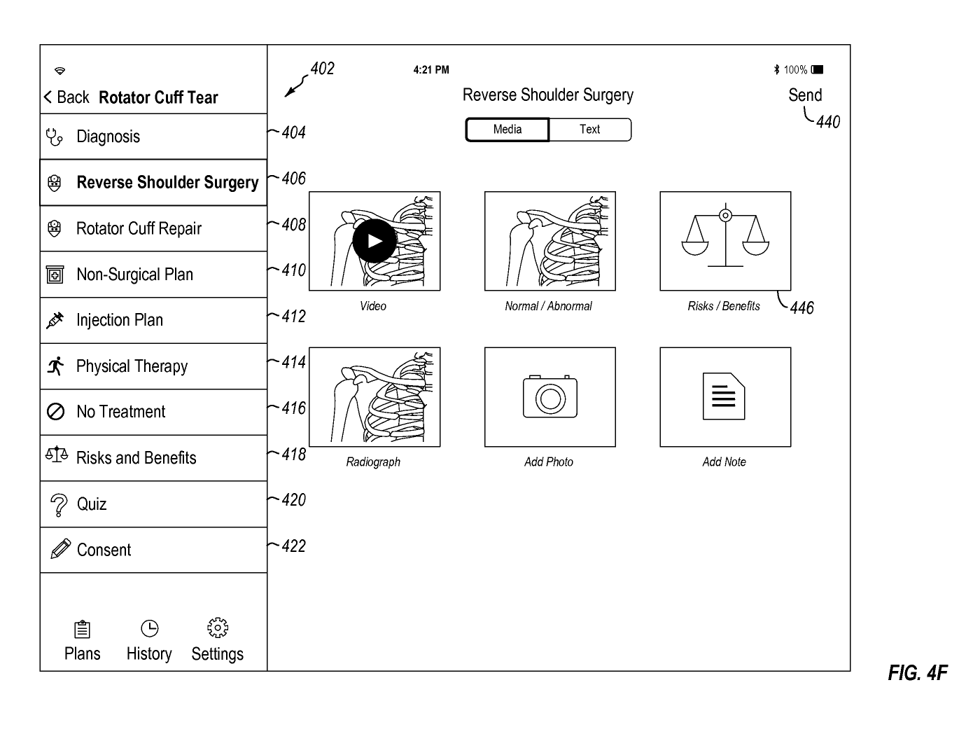

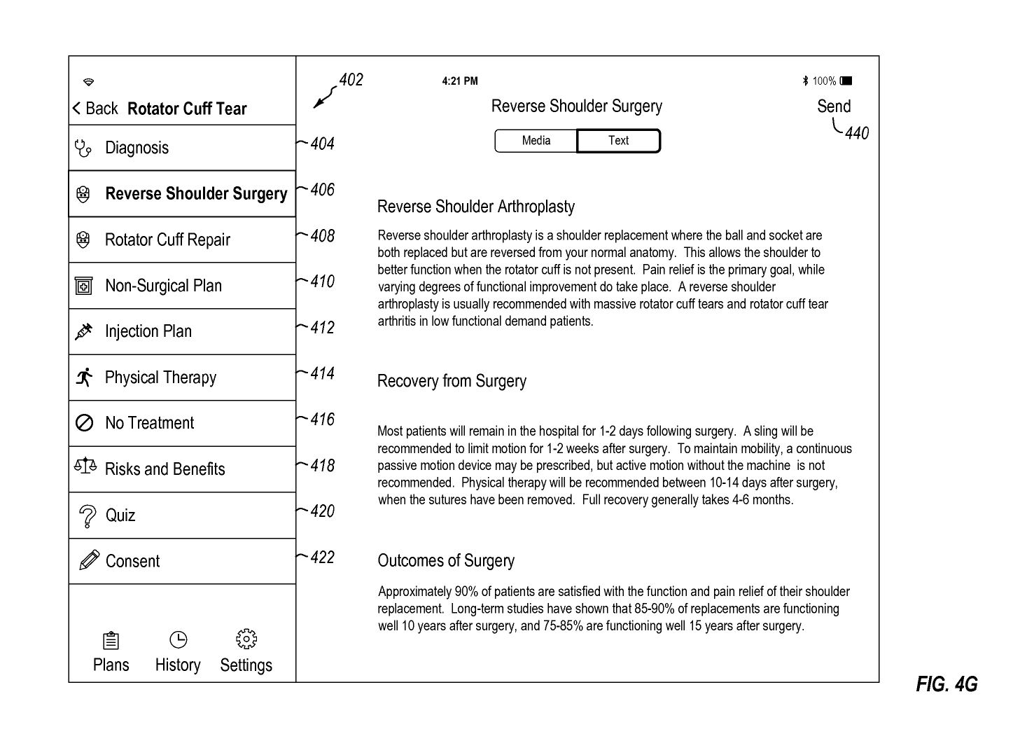

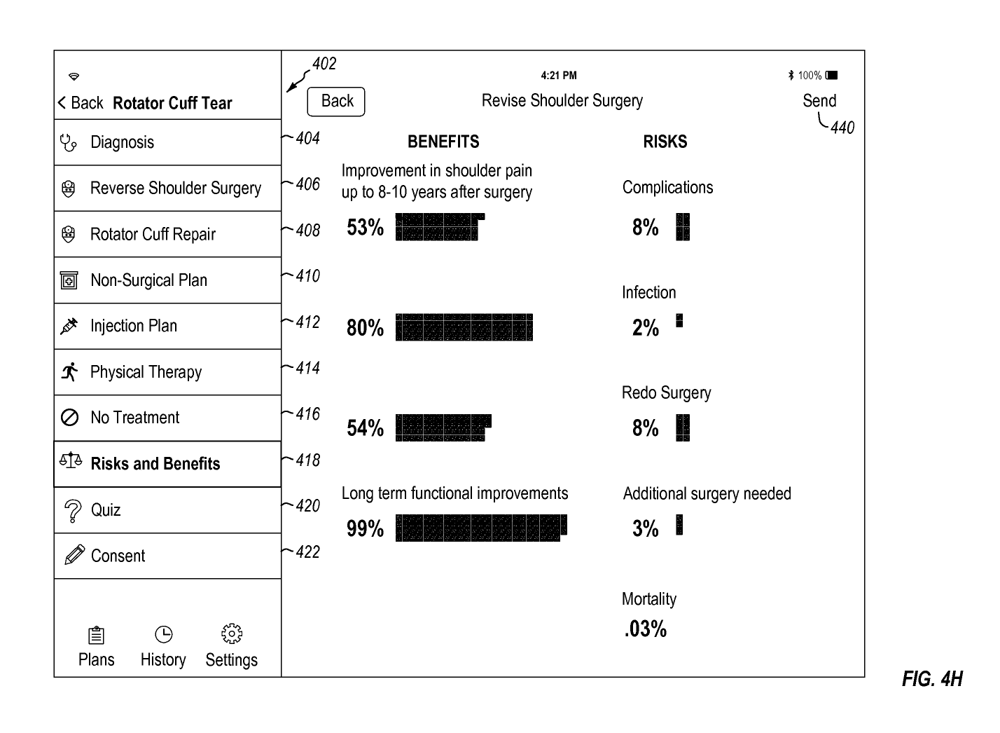

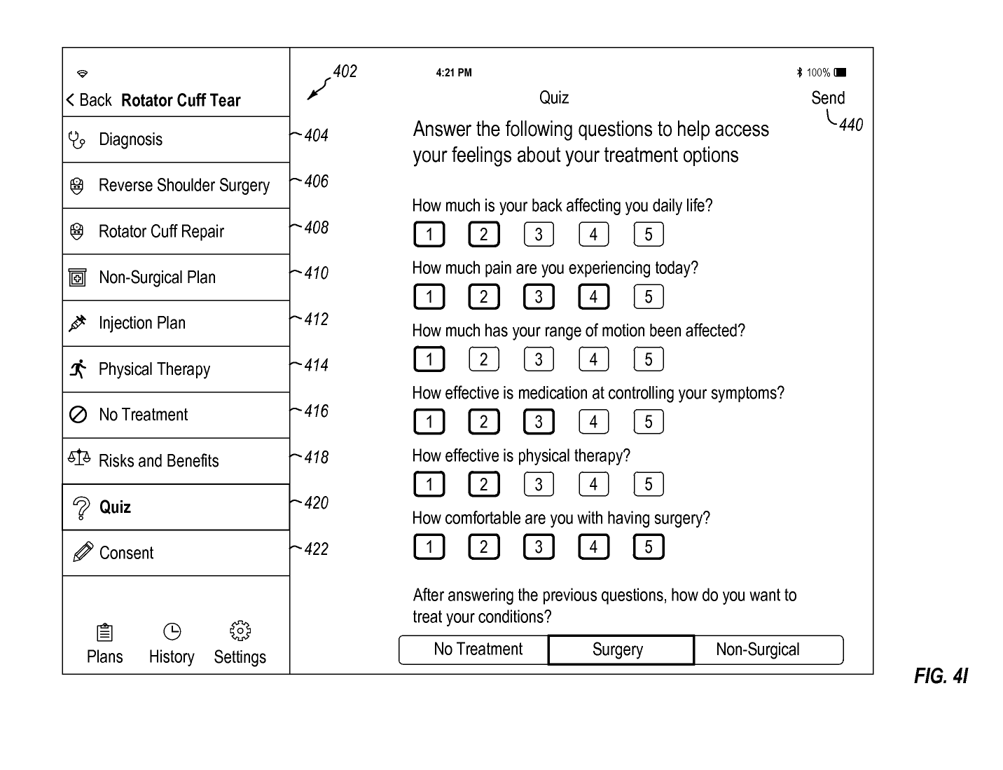

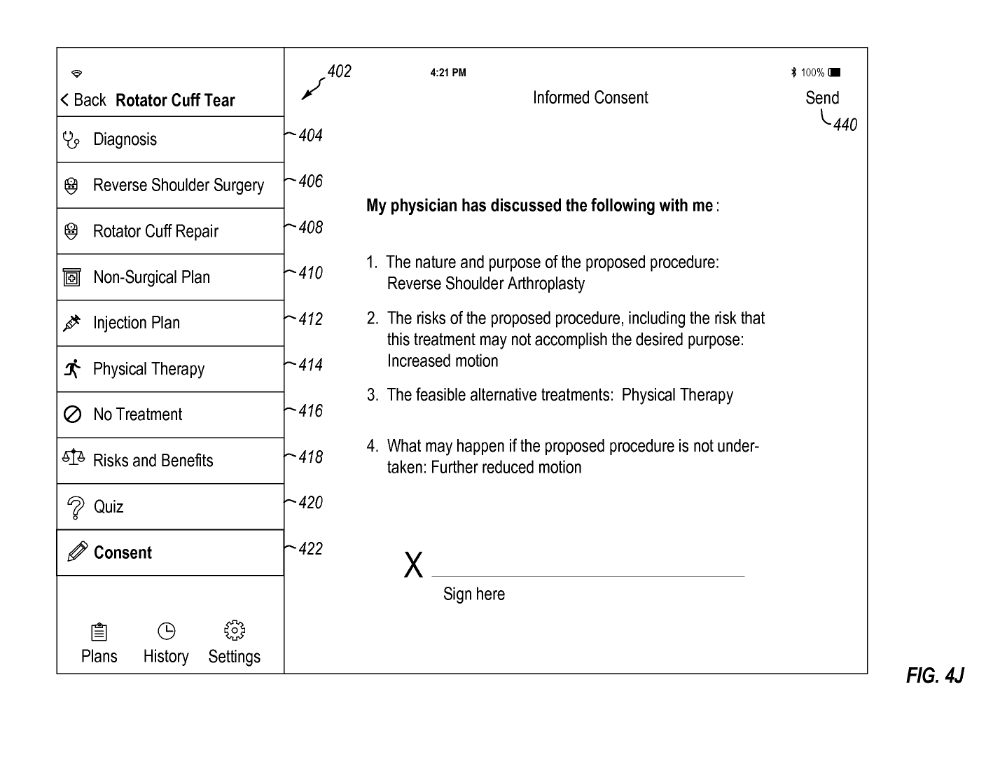

The flow 300 begins at step 301 (Diagnosis and Decision), where a patient meets with and is examined by a physician, to identify a diagnosis and to reach a treatment decision. Step 301 may comprise a single visit, or may include a plurality of visits. Step 301 may include obtaining physiological information about the patient, such as lab tests, images (e.g., photographs, X-Rays, CT Scans, etc.), and the like. During step 301, the physician may utilize a physician system 140 to educate the patient about his condition using anatomical models, illustrations, text, etc. As such, physician system 140 can be configured to present one or more educational interfaces and/or one or more decision aid user interfaces to help educate the patient about her condition and treatment options, to ensure that the patient has reached an understanding of the risks and benefits of various treatment options (or no treatment), and to obtain informed consent from the patient. Examples of such user interfaces are presented hereinafter in FIGS. 4A-4J.

In some embodiments, the physician uses the interfaces of FIGS. 4A-4J (or other interfaces) to develop a prescription for the patient that includes information that is to be sent to the patient. Such prescription information can include, for example, the educational materials (e.g., 3D models, 2D illustrations, textual material, audio, video, etc.) that were presented during the visit, additional educational material relevant to the condition, copies of the patient's own lab results and/or images (e.g., photographic, X-Ray, CT Scan, etc.), quiz questions, consent forms, prescriptions for products, services, or lifestyle changes (e.g., physical therapy, drugs, dietary changes).

At step 302 (Send Content), the physician sends information selected in step 302 to the patient. For example, the physician may use one or more user interfaces at a physician system 140 to send an electronic communication (e.g., e-mail, push notification, etc.) to a patient system 130. In some embodiments, the physician sends the actual content that is included in the prescription to the patient. In other embodiments, the physician sends access information (e.g., a URL, a username, a password, etc.) to the patient, which enables the patient to then retrieve the content from the server system(s) 110. In some embodiments, the content that the physician sends to the patient includes the prescription that was described above and that was developed during step 301.

At step 303 (Interact With Content), the patient interacts with the content that the physician sent to the patient in step 302. For example, the patient may open an e-mail at a patient system 130, and view content of a prescription that was attached to the e-mail. In another example, the patient may access a URL at the patient system 130 to load a web page from the server system(s) 110 that presents content of the prescription. In yet another example, the patient may access an application to view content of the prescription on the patient system 130. In some embodiments, the patient may access a smartphone or tablet application that is the same application that the physician used on the physician system 140 in step 301 to educate the patient about his condition and treatment options. In other embodiments, the patient may access a smartphone or tablet application that is a patent version of the physician's application.

In some embodiments, step 303 includes the patient system 130 presenting one or more user interfaces (e.g., one or more of the user interfaces of FIGS. 4A-4J) to review information about the condition; to review lab results, images (e.g., X-ray, CT scan, etc.) of the patient's own anatomy; to review treatment options; to review risks and benefits of different treatment options; to participate in quizzes that ascertain the patient's understanding of the condition and the treatment options; and/or to receive informed consent for a particular treatment option.

Step 303 can include the physician receiving feedback from the patient's consumption of the content that was sent to the patient. For example, the physician may be notified of which items of content were viewed and/or interacted with, the results of quizzing or evaluation questions, the patient's informed consent results, other free-form questions that are posed by the patient, etc. In some embodiments, the patient system 130 uploads such feedback to the server system(s) 110, where the physician can access the information. For example, the physician may log in to a web page at server system(s) 160 to access the feedback. In another example, the server system(s) 160 can send a notification to the physician system 140, allowing the physician to access the feedback at the physician system 140 (e.g., though a smartphone or tablet application). In other embodiments, the patient system 130 sends the feedback to the physician system(s) 140 without use of the server system(s) 160.

In step 304 (Recovery), the patient recovers from a treatment procedure. During recovery, the patient can continue to access content that was sent from the physician (physician system 140) to the patient (patient system 130) as part of step 302, or additional content that was subsequently sent (e.g., content sent prior to, during, and after a treatment procedure). In addition, in step 305 (Collect Data) the physician can collect data from the patient. For example, the physician may send the patient questionnaires, etc. using physician system 140 to ascertain how the patient's recovery is proceeding. Additionally or alternatively, the patient can send the physician updates, ask questions of the physician, etc. through the patient system 130 (e.g., as part of the smartphone or tablet application the patient used to interact with content in step 303).

In step 306 (Assess/Evaluate) the physician uses data collected from the patient in step 305 to assess and evaluate the patient's recovery. At step 306, the physician may make modifications to the patient's treatment and/or recovery plan, and send those changes to the patient using the physician system 140. In addition, the physician may use information collected in step 305 to influence future diagnosis and treatment decisions for this, or for other, patients.

In some embodiments, the server system(s) 160 performs analytics on the data collected in step 305 to, for example, identify patterns in how patients responded to particular forms of treatment. Such analytics may consider the patient's own efforts in the recovery process (e.g., how well the patient followed the physician's instructions). The server system(s) 160 can present this analysis to the physician using any appropriate manner, including charts, graphs, etc.

### User Interfaces

FIGS. 4A-4J illustrate some example educational/decision aid user interfaces. These user interfaces would typically be displayed on a physician system 140 or a patient system 130, such as a tablet computer. From the physician's perspective, the user interfaces can be configured to guide the patient through various pieces of educational information while the patient is in the physician's office. Such educational information can include, for example, information about a condition (diagnosis), the consequences of no treatment, information about nonsurgical treatment options, information about surgical treatment options, the risks and benefits of various treatment options, quiz questions to ascertain the patient's understanding of the materials presented to him, a consent form, etc. From the patient's perspective, the user interfaces can provide the patient access to any content prescribed by the physician, enable the patient to take quizzes and respond to consent forms, and enable the patient to send and receive communications from the physician.

The education/decision aid user interfaces of FIGS. 4A-4J can be configured to enable the user to select one or more items of content for addition to a prescription. For example, the physician may be enabled to flag any item of content (e.g., an anatomical image, a radiographic image, a video, etc.) for addition to a prescription. Then, using a send button 440, the physician can send that prescription to the patient, along with any additional notes or instructions. As such, at any time and from any of these example interfaces, the physician may be enabled to add additional material to a prescription and to initiate sending of the content to the patient. Although the selection mechanisms are not expressly depicted in FIGS. 4A-4J, one of ordinary skill in the art will appreciate that there are a vast array of user interface tools to enable such selections, including long-presses, double-taps or clicks, right clicks, entry of a selection mode, etc.

FIG. 4A illustrates an example education/decision aid user interface for a particular medical condition (a rotator cuff tear, in the depicted example). The user interface includes a content area 400 and a navigation area 402. The navigation area can include selection from among a plurality of content types related to the particular medical condition that can be displayed in the content area 400. For example, the depicted navigation area 402 includes selection from among diagnosis 404 content, surgical treatment content (e.g., the depicted reverse shoulder surgery 406 and rotator cuff repair 408 content options), non-surgical treatment content 410, other treatment options (e.g., the depicted injection plan 412 and physical therapy 414 content options), content that describes the consequences of no treatment 416, content describing risks and benefits 418 of treatment options, quiz content 420 that tests the user's knowledge of the content they have viewed or have been presented, and consent content 422 that can be used to obtain a record of informed consent from the patient for performance of a treatment.

In FIG. 4A, the diagnosis 404 content option is selected, and the content area 400 presents informational items related to the selected medical condition (a rotator cuff tear, in the depicted example). In this content context, the content area includes a media selector 424 (for viewing media content) and a text selector 426 (for viewing textual content). Since the media selector 424 is enabled, the content area presents a selection of media content options. For example, media content can include anatomical models 428, videos 430, comparisons between normal and abnormal anatomy 432, the patient's own imagery such as the depicted radiographic image 434, and one or more options to add additional content such as imagery of the patient's condition (e.g., the depicted add photo 436 and add note 438 options).

In FIG. 4B, the diagnosis 404 content option remains selected, such that the content area 400 continues to present content related to a rotator cuff tear. In FIG. 4B, however, the text selector 426 is enabled, and thus the content area 400 presents a textual description of a rotator cuff tear.

FIG. 4C presents an education/decision aid user interface that provides one or more anatomical models. For example, the anatomical educational interface of FIG. 4C may be presented upon selection of the anatomy 428 button in the user interface of FIG. 4A. The interface of FIG. 4C, and other similar interfaces, may be used by a physician on a mobile device (e.g., smartphone or tablet) to educate a patient while the patient is in the physician's presence. The interface of FIG. 4C, can also be used later, by the patient, to browse content that was prescribed by the physician. Such interfaces can present information about anatomical structures using 3D models, 2D illustrations, photographs, videos, text, audio, etc. As such, the physician can use rich animation and imagery to educate patients about conditions, treatment options, etc.

Some examples of anatomical educational interfaces that can be provided by the embodiments described herein include the interfaces, products, and services described in the following U.S. patent applications and patents: (Ser. No. 13/093,272, Ser. No. 13/167,610, Ser. No. 13/167,600, Ser. No. 13/237,530, Ser. No. 13/838,865, Ser. No. 13/477,794, Ser. No. 13/663,820, Ser. No. 13/754,250, Ser. No. 13/720,196, and Ser. No. 13/747,595), including interfaces for exploring and learning about anatomical structures, treatments, conditions, and so forth. The entire contents of the foregoing U.S. patent applications and patents are hereby incorporated herein in their entirety.

As depicted in FIG. 4C, an anatomical educational interface can include an annotate option 442. FIG. 4D illustrates that upon selection of the annotation option 442, the user may be presented with an annotation user interface that enables the user to add custom annotations to imagery, animations, videos, etc. As such, a prescription can include, along with stock imagery and media, specialized annotations that were added to the imagery/media by a physician for a particular patient.

FIG. 4E presents a normal/abnormal interface. The normal/abnormal interface of FIG. 4E may be presented, for example, upon selection of the normal/abnormal button 432 in FIG. 4A. The normal/abnormal interface of FIG. 4E can include a normal/abnormal toggle 444 that can be used to toggle between normal and abnormal anatomical images (e.g., illustrations, models, photographs, radiographic images, etc.). In some embodiments, the different views (i.e., normal and abnormal) are selected by touching or clicking on an appropriate portion of the abnormal/normal toggle 444.

In some embodiments, the different views may be toggled (in the case of a touch-sensitive interface) by merely tapping (e.g., single-tap, double-tap, triple-tap) with one or more fingers on the anatomical image or surrounding whitespace. This “tap-to-toggle” feature may be more broadly applicable to any user interface that includes a toggle function between one or more items. For example, the “tap-to-toggle” feature may also be used in connection with the interface of FIG. 4A to toggle between media and text views, instead of using the media selector 424 and the text selector 426.

FIGS. 4F and 4G illustrate an education/decision aid user interface in which the option 406 for reverse shoulder surgery content has been selected. As such, the content area 400 now shows media and text content designed to educate a patient or user about reverse shoulder surgery. Similar user interfaces can be presented for a variety of treatment (and non-treatment) options, including different surgeries, different nonsurgical procedures, therapy, etc. (see options 408-416).

FIG. 4H presents an education/decision aid user interface, in which the risks and benefits 418 content option has been selected. The risks and benefits content is designed to educate a user about the risks and benefits of a particular treatment option. In some embodiments, selection of the risks and benefits 418 content option presents a selection of available procedures (e.g., surgical or nonsurgical) for presentation of risks/benefits content for that particular procedure. In some embodiments, each procedure option may include its own risks/benefits selection, such as the risks/benefits button 446 in FIG. 4F, which presents the risks and benefits of reverse shoulder surgery, when selected.

FIG. 4I presents an education/decision aid user interface, in which the quiz 420 content option has been selected. In some embodiments, the quiz user interface can present the patient with quiz questions to test the patient's knowledge of any educational content that was presented to the patient, to test the patient's knowledge of the medical condition, and/or to test the patient's knowledge of treatment options.

In other embodiments, the quiz user interface can present the patient with evaluation questions that are designed to gauge the patient's treatment decision preferences. For example, evaluation questions may ascertain the extent to which a condition is affecting the patient's life, the extent of the patient's symptoms, the effectiveness of any treatments, the patient's comfort level with a particular treatment option, etc. The quiz user interface can also ascertain the patient's preferred decision as to his desired treatment path.

In some embodiments, a user's answers to questions presented in the quiz user interface can affect a prescription, so as to reinforce the patient's informed treatment decision. For example, a patient's answers to an evaluation question that gauges the patient's treatment decision preferences may indicate that her symptoms are sufficiently severe and affecting her life enough as to warrant surgery. As such, content related to surgery may be automatically added to her prescription. In another example, a patient's answers to an evaluation question may indicate that he is prefers surgery as a treatment option. As such, content related to surgery may be automatically added to his prescription. In other examples, evaluation questions may indicate that a patient is not comfortable with surgery and/or that the symptoms are less severe, so content related to alternate forms of treatment (e.g., drugs, injections, therapy) may be automatically added to the patient's prescription.

In additional or alternative embodiments, a patient's answers to quiz question that gauges a patient's knowledge may affect a prescription. For example, if a user's answer to a quiz question demonstrates that the user lacks knowledge in a particular content area, then applicable educational content can be automatically added to a prescription. Conversely, if a user's answer to a quiz question demonstrates that the user has sufficient knowledge in a particular content area, then applicable educational content can be automatically removed from a prescription, even if that content was expressly added to the prescription. Content may also be added to or removed from a prescription based on quiz questions ascertaining a patient's comfort level with a particular treatment, the patient's willingness to undergo a treatment, etc.

FIG. 4J presents an education/decision aid user interface in which the consent 422 content option has been selected. As depicted, the consent user interface can present a consent form, which is customized to include a specified treatment option. The consent user interface can enable the patient to sign the consent form directly, such as by using a finger or stylus on a touch-sensitive interface.

As indicated above, a physician can use the foregoing user interfaces of FIGS. 4A-4J (e.g., at a physician system 140) to educate the patient in a face-to-face visit. Additionally or alternatively, the physician can select content available through the user interfaces of FIGS. 4A-4J for inclusion in a prescription that is to be sent to the patient. The selected content may include content that the physician previously showed to the patient, and/or may include content not yet presented to the patient. The physician can then send the prescription, along with any comments or instructions, to the patient.

The patient can view the content of the prescription at a patient system 130, by using an application (e.g., a smartphone or tablet application, whether that application be the same application that was used by the physician, or a patient version of the application that access the prescription content), by loading a webpage from server(s) 110, etc. For example when the interfaces of FIGS. 4A-4J are used at a patient system 130, the user may be enabled to browse educational content in the prescription, to take quizzes, to complete consent forms, to pose questions to a physician, etc.

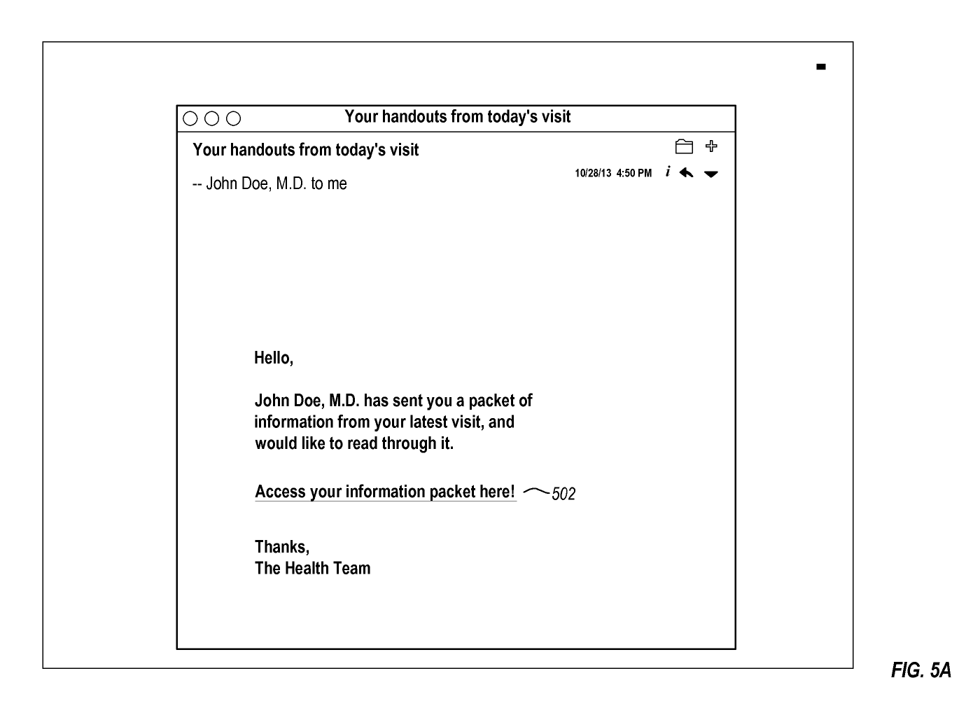

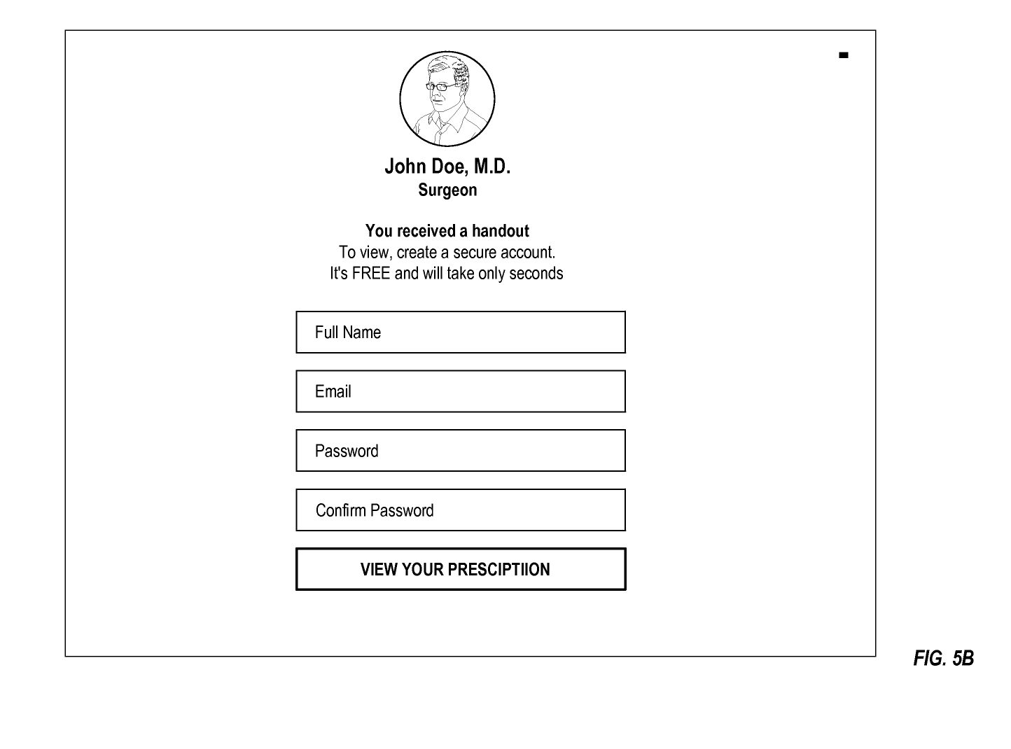

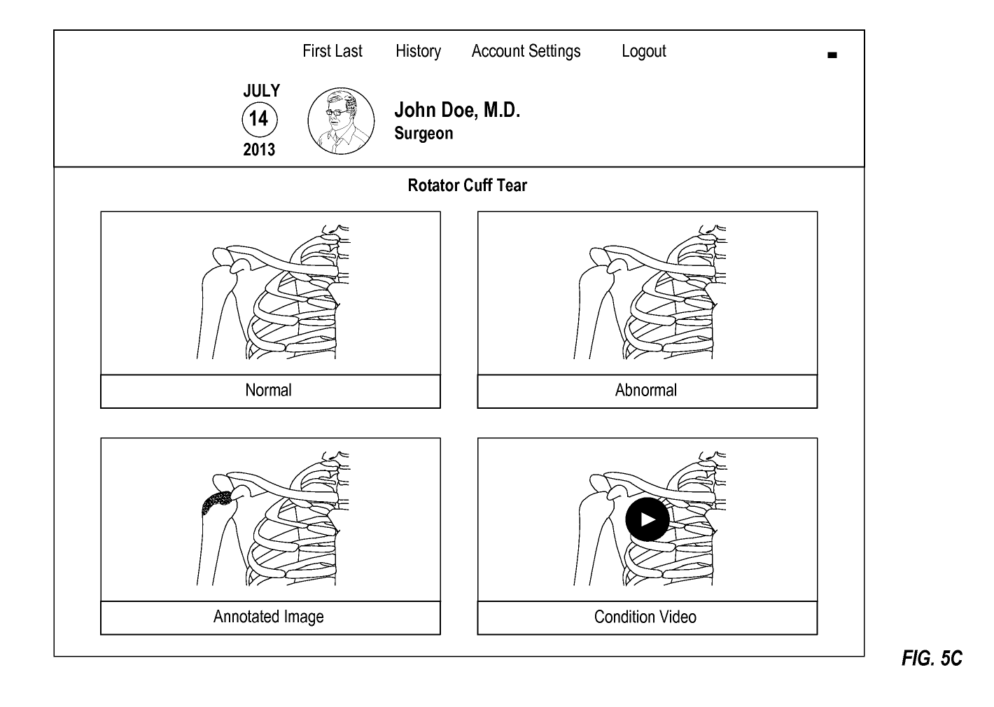

FIGS. 5A-5C illustrate example user interfaces that a patient may see as part of receiving and viewing a prescription. FIG. 5A illustrates an example e-mail or other electronic message that is received by the user. As depicted, the electronic message includes a link 502 that specifies an address at the server system(s) 110. FIG. 5B illustrates an example webpage that may be presented when the patient visits the link 502. As depicted, the webpage can prompt the user to create an account in order to view the prescription. As part of creating the account, the user may be required to provide personally identifying information (e.g., birthdate, social security number, address, etc.) that can be used to validate the identity of the patient, in order to protect the patient's privacy.

FIG. 5C presents an example web portal user interface, which presents content of the prescription that was sent to the patient. As depicted, the web portal user interface can present the content that was included in the prescription, and which was selected by the physician using the user interfaces of FIGS. 4A-4J. For example, the depicted prescription includes imagery of normal and abnormal anatomy, annotated images, videos, etc.

As discussed previously, the content available at and presented to end-user devices 120 (i.e., physician systems and/or patient systems) can be served or otherwise made available, at least in part, by server system(s) 110. In some embodiments, the server system(s) 110 are configured to enable a physician to add/edit content at the server(s).

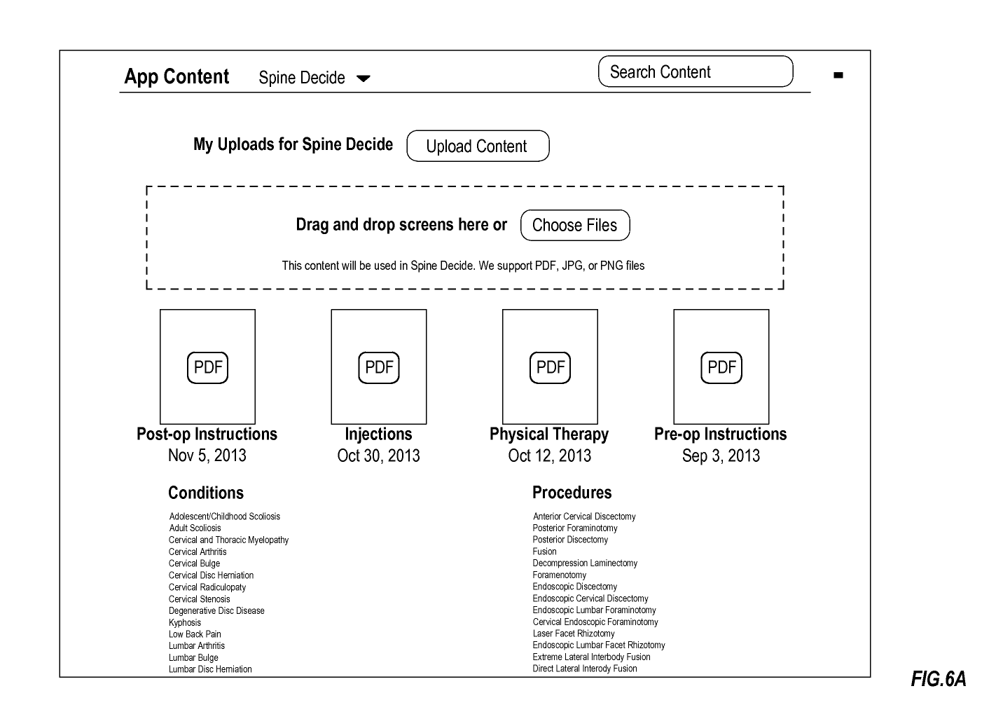

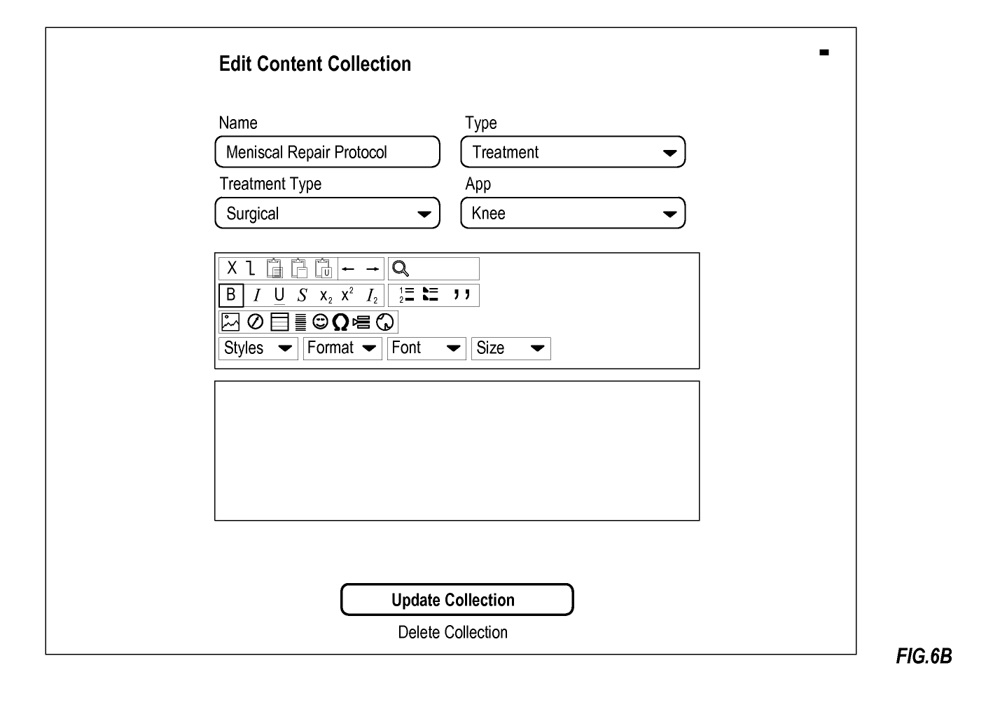

FIGS. 6A and 6B illustrate some example web user interfaces that a physician may see as part of managing, creating, and/or uploading content at the server system(s) 110. For example, the interfaces of FIGS. 6A and 6B may be presented by the server system(s) 110 as part of a web portal for physicians. FIG. 6A shows that a web portal may present functionality for a physician to select or add a content category (e.g., a particular condition or a particular procedure), and then upload content within that category. For example, the physician may be enabled to upload PDFs, images, models, and other documents, which are then made available to the end-user devices 120 through the server system(s) 110. The web portal may also provide the physician with the ability to select a particular application to which the content applies (e.g., in the depicted example, the content is relevant to an application that focuses on the spine).

FIG. 6B illustrates that, in addition to enabling uploads, a web portal may present functionality for a physician to add and/or edit content, such as textual content. For example, the interface of FIG. 6B presents a textual editor that enables a physician to select a categorization for content, and then add and edit textual content for that category. Although not expressly depicted, one of ordinary skill in the art will appreciate in view of the disclosure herein that a web portal may also provide a physician to add and edit non-textual content such as imagery, videos, illustrations, etc. Any content added or edited in the user interface of FIG. 6B may be made available to the end-user devices 120 through the server system(s) 110.

### Flowcharts

The foregoing systems and interfaces enable a variety of computer-implemented methods or process flows, which can assist a physician when diagnosing and treating a patient.

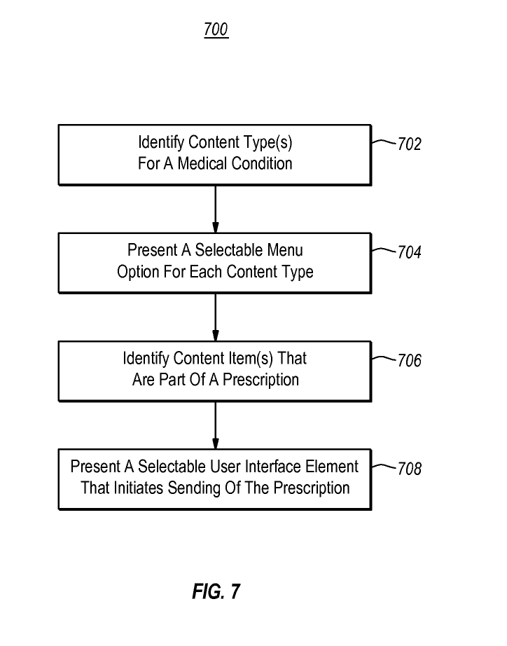

For example, FIG. 7 illustrates a method 700 for presenting a user interface for medical diagnosing and prescriptions. The method 700 can be practiced within network architecture 100 and using data flow 200, and may be used as part of the process flow 300. The method 700 can leverage one or more of the user interfaces of FIGS. 4A-4J, or variations thereof.

As depicted, the method 700 can include an act 702 of identifying content type(s) for a medical condition. Act 702 can comprise identifying a plurality of content types relative to a particular medical condition for presentation in a medical educational interface, the plurality content types being selected from among the group comprising: diagnosis, surgical treatment, non-surgical treatment, quiz, and informed consent. For example, one or more of a physician system(s) 140 and/or server system(s) 110 can identify categories of content that are to be presented at a user interface at the physician system 140. These categories can include, for example, diagnosis information for a selected medical condition; treatment options for the selected medical condition, such as surgical options and non-surgical options; physical therapy options for the selected medical condition; risks and benefits of the treatment options; quizzes related to the selected medical condition; and consent forms for procedures related to the selected medical condition.

The method 700 can also include an act 704 of presenting a selectable menu option for each content type. Act 704 can comprise presenting, at a user interface, a selectable menu option for each of the identified plurality of content types, each selectable menu option being configured to present medical content relevant to corresponding content type when selected. For example, the physician system 140 can present at the user interface a navigation area that enables selection of each of the identified categories. By way of illustration, FIGS. 4A-4J present an example navigation area 402 that can include content options 404-422, including a diagnosis category 404, a reverse shoulder surgery category 406, a rotator cuff repair category 408, a non-surgical plan category 410, an injection plan category 412, a physical therapy category 414, a no treatment category 416, a risks and benefits category 418, a quiz category 420, and a consent category 422. Of course, depending on factors such as a desired implementation and the selected condition, the particular categories that are presented may vary.

The method 700 can also include an act 706 of identifying content items that are part of a prescription. Act 706 can comprise identifying, from user input entered in connection with a selected menu option for at least one of the plurality of content types, one or more content items that are part of a prescription. For example, as a user interacts with the categories and their corresponding content using the user interfaces of FIGS. 4A-4J, some items of content may be selected for inclusion in a prescription.

In some embodiments, items of content are added to a prescription based on an express selection by a user. For example, a physician using a physician system 140 may expressly select one or more content items using any appropriate user interface mechanism (e.g., checkboxes, taps, long-presses, etc.).

In additional or in alternative embodiments, items of content are added to a prescription based on inference as a user navigates the user interface. For example, as a physician using a physician system 140 navigates content using the user interfaces of FIGS. 4A-4J, any content that the physician interacts with may be automatically added to a prescription. Thus, for example, any content that a physician shows to a patient during an office visit is automatically added to a prescription, so the patient can review the content herself at a later time.

In yet additional or alternative embodiments, items of content are added to a prescription automatically, based on a user's answer to a quiz or evaluation question. For example, as a user (e.g., patient) takes a quiz (e.g., FIG. 4I), the user's answer to a question may cause an item of content to be automatically added to a prescription. For example, if a patient's answer indicates that she is comfortable with having surgery, then content describing surgical procedures may be added to the prescription. In another example, if a patient's answer indicates that he did not understand a diagnosis, then content that educates the patient may be added to the prescription.

In addition, content may be removed from a prescription based on inference, quiz answers, etc. For example, rather than adding content to a prescription when it is interacted with at the user interfaces of FIGS. 4A-4J, interaction with content may cause it to be removed from the prescription. In another example, if a user shows that he has good knowledge of a diagnosis or surgical procedure, content that was added to a prescription expressly or through inference may be removed from the prescription.

The method 700 can also include an act 708 of presenting a selectable user interface element that initiates sending of the prescription. Act 706 can comprise presenting, at the user interface, a selectable user interface element that, when selected, initiates sending of the prescription, including the one or more content items, to a patient computer system. For example, FIGS. 4A-4J show a send button 440 that, when selected, can initiate sending a prescription to a user.

In some embodiments, selection of the send button 440 produces an e-mail composition dialogue, with which the user (e.g., a physician) can send a link to the prescription, or content of the prescription itself, to another user (e.g., a patient). In some embodiments, a record of the prescription is made at the server system(s) 110, and a reference (e.g., URL) to that prescription is sent to the other user, so that the other user can later access the prescription from the server system(s) 110.

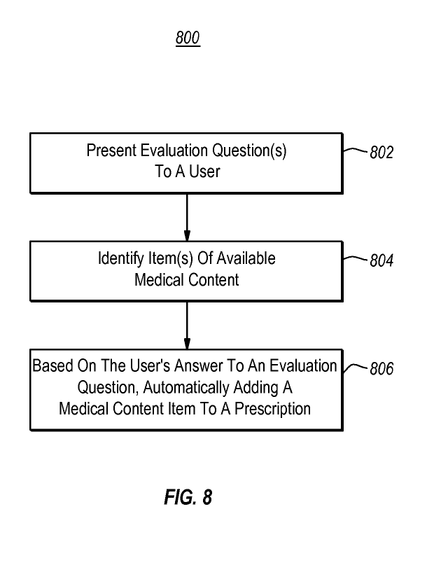

In another example, FIG. 8 illustrates a method 800 for creating a prescription. The method 800 can be practiced within network architecture 100 and using data flow 200, and may be used as part of the process flow 300. The method 800 can leverage one or more of the user interfaces of FIGS. 4A-4J, or variations thereof.

As depicted, the method 800 can include an act 802 of presenting evaluation question(s) to a user. Act 802 can comprise presenting one or more evaluation questions to a user, the evaluation questions being relevant to ascertaining a user's treatment preferences. For example, FIG. 4I depicts a user interface which presents evaluation questions relevant to ascertaining how a particular condition (rotator cuff tear) is affecting a user, how comfortable the user is with different treatment options, and the user's preferred treatment option. In addition, questions can be presented to ascertain a user's knowledge of a condition and treatment options, to ascertain the patient's comfort level with a doctor, etc.

The method 800 can also include an act 804 of identifying item(s) of available medical content. Act 804 can comprise identifying one or more items of medical content that are available for addition to a prescription and for dissemination to a user. For example, items of available medical content can include any content that is available to be accessed through the category options in the navigation area 402 (e.g., options 404-422). As such, medical content can include illustrations, photographs, videos, audio, text, documents, consent forms, etc.

The method 800 can also include an act 806 of, based on the user's answer to an evaluation question, automatically adding a medical content item to a prescription. Act 806 can comprise, based on the user's answer to at least one of the one or more evaluation questions, automatically adding at least one of the one or more items of medical content to the prescription for dissemination to the user. For example, as a user (e.g., patient) takes a quiz (e.g., FIG. 4I), the user's answer to a quiz question may cause an item of content to be automatically added to a prescription. For example, if a patient's answer indicates that she is comfortable with having surgery, then content describing surgical procedures may be added to the prescription. In another example, if a patient's answer indicates that he did not understand a diagnosis, then content that educates the patient may be added to the prescription.

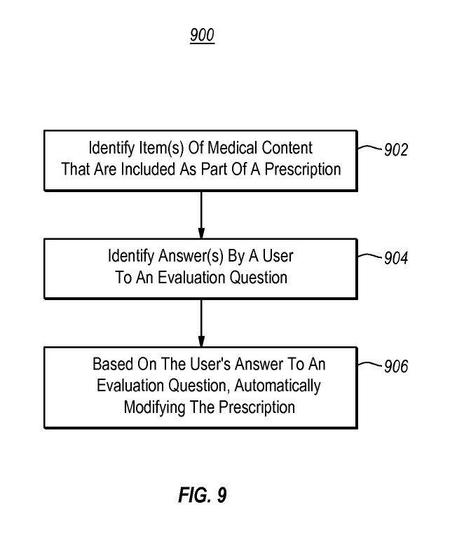

In yet another example, FIG. 9 illustrates a method 900 for modifying a prescription. The method 900 can be practiced within network architecture 100 and using data flow 200, and may be used as part of the process flow 300. The method 900 can leverage one or more of the user interfaces of FIGS. 4A-4J, or variations thereof.

As depicted, the method 900 can include an act 902 of identifying item(s) of medical content that are included as part of a prescription. Act 902 can comprise identifying one or more items of medical content that are included as part of a prescription for dissemination to a user, the one or more items of medical content included in the prescription based on one or both of an express selection by a first user or interaction with one of the items of medical content at a user interface. For example, content items may be added to a prescription as a user interacts with the categories and their corresponding content using the user interfaces of FIGS. 4A-4J.

Items of content may be added to a prescription based on an express selection by a user. For example, a physician using a physician system 140 may expressly select one or more content items using any appropriate user interface mechanism (e.g., checkboxes, taps, long-presses, etc.). In addition, items of content are added to a prescription based on inference as a user navigates the user interface, as discussed previously. For example, as a user interacts with content, it may be automatically added to a prescription.

The method 900 can also include an act 904 of identifying answer(s) by a user to an evaluation question. Act 904 can comprise identifying one or more answers by a second user to one or more evaluation questions, the evaluation questions being relevant to ascertaining the second user's treatment preferences. For example, a user may be prompted to answer one or more questions related to a selected medical condition. As discussed previously, FIG. 4I depicts a user interface in which questions relevant to a rotator cuff tear, and its treatment, are presented to a user. These questions can be used to ascertain a user's knowledge of a condition and treatment options, to ascertain how the condition is affecting the user, to ascertain a user's comfort level with a treatment option, to ascertain the patient's comfort level with a doctor, etc.

The method 900 can also include an act 906 of, based on the user's answer to an evaluation question, automatically modifying the prescription. Act 906 can comprise, based on the second user's answer to at least one of the one or more evaluation questions, automatically modifying the prescription to include at least one additional item of medical content. For example, as a user (e.g., patient) takes the quiz of FIG. 4I, the user's answer to a quiz question may cause an item of content to be automatically added to a prescription. For example, if a patient's answer indicates that she is comfortable with having surgery, then content describing surgical procedures may be added to the prescription. In another example, if a patient's answer indicates that he is not being significantly affected by the condition, then content describing non-surgical treatment options may be added to the prescription. In another example, if a patient's answer indicates that he did not understand a diagnosis, then content that educates the patient may be added to the prescription.

In addition, content may be removed from a prescription based on answers. For example, if a user shows that he has good knowledge of a diagnosis or surgical procedure, content that was added to a prescription expressly or through inference may be removed from the prescription.

Although the subject matter has been described in language specific to structural features and/or methodological acts, it is to be understood that the subject matter defined in the appended claims is not necessarily limited to the described features or acts described above, or the order of the acts described above. Rather, the described features and acts are disclosed as example forms of implementing the claims.

### General Computing Environment

Embodiments of the present invention may comprise or utilize a special-purpose or general-purpose computer system that includes computer hardware, such as, for example, one or more processors and system memory, as discussed in greater detail below. Embodiments within the scope of the present invention also include physical and other computer-readable media for carrying or storing computer-executable instructions and/or data structures. Such computer-readable media can be any available media that can be accessed by a general-purpose or special-purpose computer system. Computer-readable media that store computer-executable instructions and/or data structures are computer storage media. Computer-readable media that carry computer-executable instructions and/or data structures are transmission media. Thus, by way of example, and not limitation, embodiments of the invention can comprise at least two distinctly different kinds of computer-readable media: computer storage media and transmission media.

Computer storage media are physical storage media that store computer-executable instructions and/or data structures. Physical storage media include computer hardware, such as RAM, ROM, EEPROM, solid state drives (“SSDs”), flash memory, phase-change memory (“PCM”), optical disk storage, magnetic disk storage or other magnetic storage devices, or any other hardware storage device(s) that can be used to store program code in the form of computer-executable instructions or data structures, which can be accessed and executed by a general-purpose or special-purpose computer system to implement the disclosed functionality of the invention.

Transmission media can include a network and/or data links that can be used to carry program code in the form of computer-executable instructions or data structures, and which can be accessed by a general-purpose or special-purpose computer system. A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer system, the computer system may view the connection as transmission media. Combinations of the above should also be included within the scope of computer-readable media.

Further, upon reaching various computer system components, program code in the form of computer-executable instructions or data structures can be transferred automatically from transmission media to computer storage media (or vice versa). For example, computer-executable instructions or data structures received over a network or data link can be buffered in RAM within a network interface module (e.g., a “NIC”), and then eventually transferred to computer system RAM and/or to less volatile computer storage media at a computer system. Thus, it should be understood that computer storage media can be included in computer system components that also (or even primarily) utilize transmission media.

Computer-executable instructions comprise, for example, instructions and data which, when executed at one or more processors, cause a general-purpose computer system, special-purpose computer system, or special-purpose processing device to perform a certain function or group of functions. Computer-executable instructions may be, for example, binaries, intermediate format instructions such as assembly language, or even source code.

Those skilled in the art will appreciate that the invention may be practiced in network computing environments with many types of computer system configurations, including personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The invention may also be practiced in distributed system environments where local and remote computer systems, which are linked (either by hardwired data links, wireless data links, or by a combination of hardwired and wireless data links) through a network, both perform tasks. As such, in a distributed system environment, a computer system may include a plurality of constituent computer systems. In a distributed system environment, program modules may be located in both local and remote memory storage devices.

Those skilled in the art will also appreciate that the invention may be practiced in a cloud computing environment. Cloud computing environments may be distributed, although this is not required. When distributed, cloud computing environments may be distributed internationally within an organization and/or have components possessed across multiple organizations. In this description and the following claims, “cloud computing” is defined as a model for enabling on-demand network access to a shared pool of configurable computing resources (e.g., networks, servers, storage, applications, and services). The definition of “cloud computing” is not limited to any of the other numerous advantages that can be obtained from such a model when properly deployed.

A cloud computing model can be composed of various characteristics, such as on-demand self-service, broad network access, resource pooling, rapid elasticity, measured service, and so forth. A cloud computing model may also come in the form of various service models such as, for example, Software as a Service (“SaaS”), Platform as a Service (“PaaS”), and Infrastructure as a Service (“IaaS”). The cloud computing model may also be deployed using different deployment models such as private cloud, community cloud, public cloud, hybrid cloud, and so forth.

Some embodiments, such as a cloud computing environment, may comprise a system that includes one or more hosts that are each capable of running one or more virtual machines. During operation, virtual machines emulate an operational computing system, supporting an operating system and perhaps one or more other applications as well. In some embodiments, each host includes a hypervisor that emulates virtual resources for the virtual machines using physical resources that are abstracted from view of the virtual machines. The hypervisor also provides proper isolation between the virtual machines. Thus, from the perspective of any given virtual machine, the hypervisor provides the illusion that the virtual machine is interfacing with a physical resource, even though the virtual machine only interfaces with the appearance (e.g., a virtual resource) of a physical resource. Examples of physical resources include processing capacity, memory, disk space, network bandwidth, media drives, and so forth.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed:

1. A computer system, comprising:
one or more hardware processors; and
one or more hardware storage devices having stored thereon computer-executable instructions that, when executed by the one or more hardware processors, cause the computer system to implement a method for presenting a user interface for medical diagnosing and prescriptions, including the following:
identifying a plurality of content types relative to a particular medical condition for presentation in a medical educational interface, the plurality content types being selected from among the group comprising: diagnosis, surgical treatment, non-surgical treatment, quiz, and informed consent;
presenting, at a user interface, a selectable menu option for each of the identified plurality of content types, each selectable menu option being configured to present medical content relevant to corresponding content type when selected;
identifying, from user input entered in connection with a selected menu option for at least one of the plurality of content types, one or more content items that are part of a prescription; and
presenting, at the user interface, a selectable user interface element that, when selected, initiates sending of the prescription, including the one or more content items, to a patient computer system.

2. The computer system as recited in claim 1, wherein one or more items of medical content is retrieved from a remote server computer system.

3. The computer system as recited in claim 1, wherein at least one of the one or more content items that are part of the prescription is automatically selected based on a user's answer to an evaluation question.

4. The computer system as recited in claim 1, wherein at least one of the one or more content items that are part of the prescription is automatically selected based on content that was interacted with at the user interface.

5. The computer system as recited in claim 1, wherein at least one of the one or more content items that are part of the prescription is selected based on an express selection by a user.

6. The computer system as recited in claim 1, wherein at least one of the one or more content items that are part of the prescription is added by a user during use of the user interface.

7. The computer system as recited in claim 1, wherein the plurality content types includes each of diagnosis, surgical treatment, non-surgical treatment, quiz, and informed consent.

8. The computer system as recited in claim 1, wherein the user interface is configured to toggle between two or more types of content based on a tapping gesture, comprising a user tapping a content portion of a user interface.

9. A computer system, comprising:
one or more hardware processors; and
one or more hardware storage devices having stored thereon computer-executable instructions that, when executed by the one or more hardware processors, cause the computer system to implement a method for creating a prescription, including the following:
presenting one or more evaluation questions to a user, the evaluation questions being relevant to ascertaining a user's treatment preferences;
identifying one or more items of medical content that are available for addition to a prescription and for dissemination to a user; and
based on the user's answer to at least one of the one or more evaluation questions, automatically adding at least one of the one or more items of medical content to the prescription for dissemination to the user.

10. The computer system as recited in claim 9, further comprising presenting one or more quiz questions to the user, the quiz questions being relevant to testing the user's knowledge of one or both of a medical condition or a medical treatment, and wherein the at least one item of medical content is added to the prescription based on identifying from an answer to a quiz question that the user has a poor understanding of a medical topic related to the at least one of the one or more items of medical content.

11. The computer system as recited in claim 9, wherein the at least one item of medical content is added to the prescription based on identifying from an answer to an evaluation question one or both of the user's comfort level with a treatment option, and the user's preferred treatment option.

12. The computer system as recited in claim 9, further comprising:
adding at least an additional item of medical content to the prescription for dissemination to the user based on an express selection of the additional item of medical content by another user.

13. The computer system as recited in claim 8, wherein the additional item of medical content comprises one or more of an electronic prescription for a pharmaceutical drug, an order for a laboratory test, or an order for imaging.

14. The computer system as recited in claim 9, further comprising:
automatically adding at least an additional item of medical content to the prescription for dissemination to the user based on a user's viewing of the additional item of medical content at a user interface.

15. The computer system as recited in claim 9, wherein the at least one item of medical content comprises interactive digital content.

16. A computer system, comprising:
one or more hardware processors; and
one or more hardware storage devices having stored thereon computer-executable instructions that, when executed by the one or more hardware processors, cause the computer system to implement a method for modifying a prescription, including the following:
identifying one or more items of medical content that are included as part of a prescription for dissemination to a user, the one or more items of medical content included in the prescription based on one or both of an express selection by a first user or interaction with one of the items of medical content at a user interface;
identifying one or more answers by a second user to one or more evaluation questions, the evaluation questions being relevant to ascertaining the second user's treatment preferences; and
based on the second user's answer to at least one of the one or more evaluation questions, automatically modifying the prescription to include at least one additional item of medical content.

17. The computer system as recited in claim 15, further comprising presenting one or more quiz questions to the user, the quiz questions being relevant to testing the user's knowledge of one or both of a medical condition or a medical treatment, and wherein the at least one additional item of medical content is added to the prescription based on identifying from an answer to a quiz question that the second user has a poor understanding of a medical topic related to the at least one additional item of medical content.

18. The computer system as recited in claim 15, wherein the at least one additional item of medical content is added to the prescription based on identifying from an answer to an evaluation question one or both of the user's comfort level with a treatment option, and the user's preferred treatment option.

19. The computer system as recited in claim 15, further comprising:
sending the prescription to a computer system associated with the second user.

20. The computer system as recited in claim 15, wherein the first user is a physician and the second user is a patient.
